(19) United States
(12) Patent Application Publication
(10) Pub. No.: US 2022/0112612 A1
(43) Pub. Date: Apr. 14, 2022

(54) PARALLEL CONFIGURATION OF ELECTROLYSIS CELLS

(71) Applicant: Analog Devices, Inc., Wilmington, MA (US)

(72) Inventors: Antonio Montalvo, Raleigh, NC (US); Michael Alfred Kultgen, Denver, CO (US)

(21) Appl. No.: 17/108,184

(22) Filed: Dec. 1, 2020

Related U.S. Application Data
(60) Provisional application No. 63/090,853, filed on Oct. 13, 2020.

(51) Int. Cl. C25B 9/65; C25B 1/04; C25B 9/17; C25B 9/70; C25B 15/023

(52) U.S. Cl. CPC C25B 9/65; C25B 1/04; C25B 15/023; C25B 9/70; C25B 9/17

(57) ABSTRACT

Systems and methods are provided for operating an electrolyzer. The electrolyzer comprising a plurality of electrolytic cells, each of the electrolytic cells comprising an electrolyte and two electrodes, the systems and methods comprising: a common voltage converter coupled in parallel to the plurality of electrolytic cells and configured to distribute power to the plurality of electrolytic cells; and control circuitry coupled to the plurality of electrolytic cells, the control circuitry configured to: monitor one or more parameters of the plurality of electrolytic cells; and generate, based on the one or more parameters, a model representing operating conditions of the electrolytic cells on an individual electrolytic cell basis.

### CROSS-REFERENCE TO RELATED APPLICATION

This application claims the benefit of priority to U.S. Provisional Application No. 63/090,853, filed on Oct. 13, 2020, which is incorporated herein by reference in its entirety.

### FIELD OF THE DISCLOSURE

This document pertains generally, but not by way of limitation, to electrolysis cells.

### BACKGROUND

Fuel cells are used to convert chemical energy (usually from hydrogen) to electrical energy. Since each fuel cell usually produces between 1 and 2 volts, oftentimes such fuel cells are stacked in series in order to produce a high power at a relatively low current. Hydrogen can also be generated with similar devices. Instead of hydrogen and oxygen as inputs and electrons as the desired output, the inputs are electricity and water and hydrogen is the desired output.

### Overview

This disclosure describes, among other things, techniques to operating electrolysis cells.

In some embodiments, a system is provided that includes an electrolyzer comprising a plurality of electrolytic cells, with each of the electrolytic cells comprising an electrolyte and two electrodes. The system comprises a common voltage converter coupled in parallel to the plurality of electrolytic cells and configured to distribute power to the plurality of electrolytic cells; and control circuitry coupled to the plurality of electrolytic cells, the control circuitry configured to: monitor one or more parameters of the plurality of electrolytic cells, and generate, based on the one or more parameters, a model representing operating conditions of the electrolytic cells on an individual electrolytic cell basis.

In some embodiments, the one or more parameters include at least one of voltage across one or more of the plurality of electrolytic cells, electro impedance spectroscopy (EIS), current, temperature, and gas or fluid flow associated with the one or more of the plurality of electrolytic cells.

In some embodiments, the system includes an intermediate voltage distribution device configured to provide an intermediate voltage to the common voltage converter.

In some implementations, the electrolytic cells include individual power supplies that reduce a voltage level of the power received from the voltage converter.

In some implementations, the electrolyte comprises a water solution, and wherein the electrolyzer is configured to output hydrogen and oxygen.

In some implementations, a first of the electrolytic cells includes a first controller and a second of the electrolytic cells includes a second controller. In some implementations, the first controller generates a model representing an operating condition of the first electrolytic cell based on one or more parameters of the first electrolytic cell.

In some embodiments, the system includes a communication interface coupled to the plurality of electrolytic cells, wherein the control circuitry communicates with a first of the plurality of electrolytic cells using the communication interface and obtains a parameter from the first of the plurality of electrolytic cells.

In some implementations, the parameter comprises an impedance measurement of the first electrolytic cell.

In some implementations, the control circuitry is configured to apply a current set of parameters of a given electrolytic cell of the plurality of electrolytic cells to the model, wherein the model is configured to estimate health or performance of the given electrolytic cell based on the current set of parameters.

In some implementations, the model comprises a machine learning technique that is trained based on training data to predict health of an electrolytic cell, the training data comprising a plurality of training parameters and associated performance or failure information for the plurality of training parameters.

In some implementations, the control circuitry comprises an analog to digital converter for measuring an analog value that represents the one or more parameters and for converting the analog value to a digital representation of the one or more parameters, wherein the control circuitry obtains the monitored one or more parameters over the Internet from the electrolyzer.

In some embodiments, a method is provided for performing operations comprising: providing, to an electrolyzer, power from a common voltage converter, the electrolyzer comprising a plurality of electrolytic cells, each of the electrolytic cells comprising an electrolyte and two electrodes, the common voltage converter coupled in parallel to the plurality of electrolytic cells; monitoring, by control circuitry, one or more parameters of the plurality of electrolytic cells; and generating, by the control circuitry, based on the one or more parameters, a model representing operating conditions of the electrolytic cells on an individual electrolytic cell basis.

In some implementations, the one or more parameters include at least one of voltage across one or more of the plurality of electrolytic cells, current, EIS, temperature, and gas or fluid flow associated with the one or more of the plurality of electrolytic cells. In some implementations, the electrolytic cells include individual power supplies that reduce a voltage level of the power received from the common voltage converter.

In some embodiments, the operations further comprise: selecting a first of the plurality of electrolytic cells using a communication interface; and obtaining a parameter from the selected first of the plurality of electrolytic cells.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an electrolyzer system, in accordance with various embodiments.

FIG. 2 is a block diagram of an example of an electrolyzer system, in accordance with various embodiments.

FIG. 3 is a block diagram of an example of an electrolyzer system, in accordance with various embodiments.

FIG. 4 is a flow diagram depicting example process for operating an electrolyzer, in accordance with various embodiments.

FIG. 5 is a block diagram illustrating an example of a machine upon which one or more embodiments may be implemented.

### DETAILED DESCRIPTION

This disclosure describes, among other things, techniques to configure an electrolyzer or hydrolyzer to generate hydrogen and/or oxygen.

An electrolyzer typically includes one or more electrolytic cells. Each electrolytic cell has three component parts: an electrolyte and two electrodes (a cathode and an anode). The electrolyte is usually a solution of water or other solvents in which ions are dissolved. Molten salts such as sodium chloride are also electrolytes. When driven by an external voltage applied to the electrodes, the ions in the electrolyte are attracted to an electrode with the opposite charge, where charge-transferring (also called faradaic or redox) reactions can take place. Only with an external electrical potential (i.e., voltage) of correct polarity and sufficient magnitude can an electrolytic cell decompose a normally stable, or inert chemical compound in the solution. The electrical energy provided can produce a chemical reaction which would not occur spontaneously otherwise. Water, particularly when ions are added (salt water or acidic water), can be electrolyzed (subject to electrolysis). When driven by an external source of voltage, H+ ions flow to the cathode to combine with electrons to produce hydrogen gas in a reduction reaction. Likewise, OH− ions flow to the anode to release electrons and an H+ ion to produce oxygen gas in an oxidation reaction.

A system that generates hydrogen through electrolysis is called an electrolyzer or a hydrolyzer. A power generation system produces a high voltage (between 50V and 200V) and a high current (100 A to 4000 A) that is provided to a cell stack that includes electrolytic cells that each include an electrolyte and two electrodes. With water as the other input, the cell stack produces hydrogen and oxygen as outputs. If the source of power is a renewable such as solar, wind, or hydroelectric, then the entire cycle is completely carbon free. Electrolyzer cells are typically electrically connected in series. However, such configurations have several shortcomings. For example, one challenge of electrolyzers is durability. There is a specific voltage across a cell that produces an optimum combination of efficiency and durability. If the supply voltage is too high, corrosion in the electrodes can result in an increase in impedance and a shorter lifetime of the electrolyzers. The increase in impedance in one cell changes the voltage in other cells and can degrade efficiency and/or durability.

In addition, configuring the electrolyzers in series limits the scalability of the overall system, because adding or replacing electrolytic cells introduces additional challenges. For example, if one electrolytic cell in the electrolyzer breaks down, the power distribution through the system to other cells can be impacted and the overall system may also stop functioning. Namely, when the cells are in a series configuration, when one cell fails then the entire stack fails.

According to the disclosed embodiments, a novel and resource efficient approach to operating and configuring electrolyzers is provided. The disclosed approach electrically configures the electrolytic cells in parallel. In some cases, if the cells are mechanically configured in a stack, a thin insulating layer is provided between electrolytic cells, and each electrolytic cell includes an independent power supply. In this way, performance on a per cell basis can be managed, which can be used to control parameters of other cells. Also, configuring the electrolytic cells in parallel makes the system highly scalable because adding cells to the system becomes trivial, and when one cell breaks down, power distribution, such as voltage, delivered to other cells does not significantly change.

In some embodiments, a high voltage source (e.g., a voltage source that generates between 50V and 200V) is converted to an intermediate voltage, by a common voltage converter, which is then distributed to the individual point-of-load regulators of each electrolytic cell. The point-of-load regulators generate the requisite power, such as between 1V and 2V needed to operate the individual cells. In some cases, each cell is associated with a local monitoring system that includes an analog-to-digital converter (ADC). For example, the local monitoring system can be implemented on each individual cell in which case each local monitoring system monitors its own individual cell performance. In other implementations, the local monitoring system is implemented by a central controller (in which case the local monitoring system is a central monitoring system) that communicates with each individual cell to obtain the performance measurement parameters. Specifically, the local monitoring system (or central monitoring system) measures one or more analog values to generate a set of one or more parameters in analog or digital form. The local/central monitoring system uses the set of one or more parameters to generate a model that represents the performance or failure of the associated cell and/or a collection of cells. The ADC implemented on the particular cell can measure voltages, currents, and temperature at various locations in the cell to generate the one or more parameters. The central monitoring system can gather one or more parameters from all of the cells in a system or the central monitoring system can access data from many electrolyzer systems in the cloud.

In some cases, a central monitoring system, such as a server or control circuitry accessible over the Internet on the cloud, monitors the voltage and/or current across each cell, and the current, temperature and/or other parameters such as gas and fluid flow. The information is used to monitor the performance of the system and to estimate the state-of-health of each cell on an individual basis. The performance and health estimation system may employ artificial intelligence or machine learning techniques (AI/ML) or other algorithmic techniques to process data from one or many cells. The AI/ML techniques can be trained to predict performance and/or failure on an individual cell basis based on training data. In this way, the individual and independent power supplies of each electrolytic cell can be adaptively controlled to deliver the optimal voltage and power to the individual cell to optimize performance and increase durability of the cell.

One advantage of parallel cells over series cells is durability. Namely, if the failure of a single cell can be predicted, it can be disabled leaving the rest of the system substantially unaffected. If, for example, there are 100 cells in a system, the result of a failure is just 1% reduction in output. Another advantage is ease of monitoring. Specifically, since all cells are at a relatively low voltage, the monitors can all be powered by the same relatively low voltage power supply and monitors can communicate with each other without the need for any isolation barriers. A single monitor could be used to monitor many cells by employing multiplexing switches. In this way, cells can be powered up/down or the parameters of the individual cells can be individually retrieved and analyzed. Additionally, being able to isolate individual cells simplifies the impedance measurement.

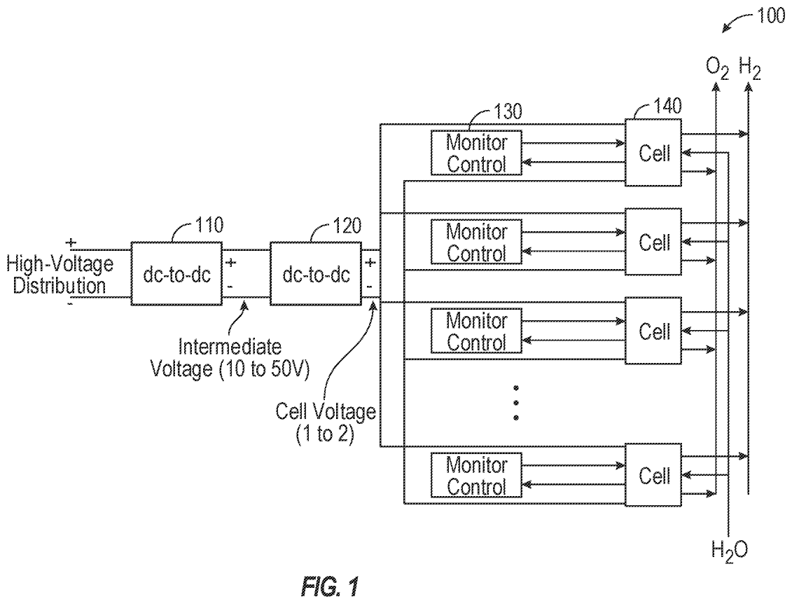

FIG. 1 is a block diagram of an example of an electrolyzer system 100, in accordance with various embodiments. In this embodiment, the cells are connected electrically in parallel and each cell is driven by a common voltage source. The electrolyzer system 100 includes a main high-voltage distribution device 110 configured to provide an intermediate voltage to the point-of-load voltage converter 120. For example, the high-voltage distribution device 110 can provide a voltage between 10 and 50 volts. The intermediate voltage converter 120 reduces the voltage to a range of 1 volts and 2 volts.

The intermediate voltage converter 120 (common voltage converter) can generate a voltage between 1-2 volts and distribute that power to a plurality of electrolytic cells 140 in parallel. Each electrolytic cell 140 includes an electrolyte coupled to receive a solution (e.g., water) and two electrodes. The electrodes can be connected to the intermediate voltage converter 120. Each electrolytic cell 140 outputs oxygen and hydrogen. The rate of output depends on the power received by the electrodes of the cell. In some cases, a higher power can generate oxygen and hydrogen at a faster rate but this reduces durability of the system. On the other hand, a lower power can generate oxygen and hydrogen at a slower rate but increase durability of the system.

Each of the electrolytic cells 140 are coupled electrically in parallel to each other and to the intermediate voltage converter 120. A monitor control circuit 130 (e.g., a local monitor circuit) is associated with (and implemented by) each cell. The monitor control circuit 130 collects parameters of the respective cells 140 on an individual basis. For example, the monitor control circuit 130 associated with a first cell 140 implements a ADC to measure voltages across various cell components to collect any one or combination of parameters, including voltage across one or more of the plurality of electrolytic cells, electro impedance spectroscopy (EIS), current, temperature, and gas or fluid flow. In some cases, the monitor control circuit 130 includes a processor that implements a model for the respective cell that predicts or determines performance of the cell and/or predicts or determines a failure of the cell. The monitor control circuit 130 can disable the associated cell in response to determining that the current parameters are indicative and associated with an upcoming failure of the cell.

For example, a machine learning model can be trained based on training data to predict performance and/or failure of a given cell. This trained machine learning model can then be implemented by each monitor control circuit 130 to operate on an analyze real-time parameters measured and collected from the respective cell 140.

As an example, the machine learning model be a neural network. The neural network is trained to establish a relationship between a plurality of operating parameters (e.g., voltage across one or more of the plurality of electrolytic cells, EIS, current, temperature, and gas or fluid flow associated with the one or more of the plurality of electrolytic cells) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. The neural network can be trained to establish a set of parameters of the neural network based on such data to minimize a loss function. For example, the neural network can predict failure or performance metrics given a set of parameters in a set of the training data. The predicted failure or performance metrics can be compared with the actual ground truth failure or performance metrics of the set of training data. A loss can be computed based on a deviation between the predicted failure or performance metrics and the ground truth failure or performance metrics. Parameters of the neural network can then be updated based on the computed loss. Subsequent or additional training data sets can similarly be processed to update parameters of the neural network until a stopping criterion is satisfied or until all of the training data is processed.

This neural network with such updated parameters can then be stored or implemented by the monitor control circuits 130. In this way, when the neural network of a given monitor control circuit 130 is presented with a new set of parameters of a given cell 140, the neural network can predict failure or performance metrics of the given cell 140. Based on the failure or performance metrics, voltage being delivered to the individual cell 140 can be adjusted to optimize the failure or performance metrics.

In some cases, the monitor control circuit 130 of each cell 140 communicates the collected parameters to a cloud server over the Internet, such as a control circuitry. The cloud server can then use a global model (e.g., another neural network) to determine or predict the performance of the overall electrolyzer system 100 and can vary the voltage or power delivered to the system 100 or cell 140 by the high-voltage distribution device 110 and/or the intermediate voltage converter 120.

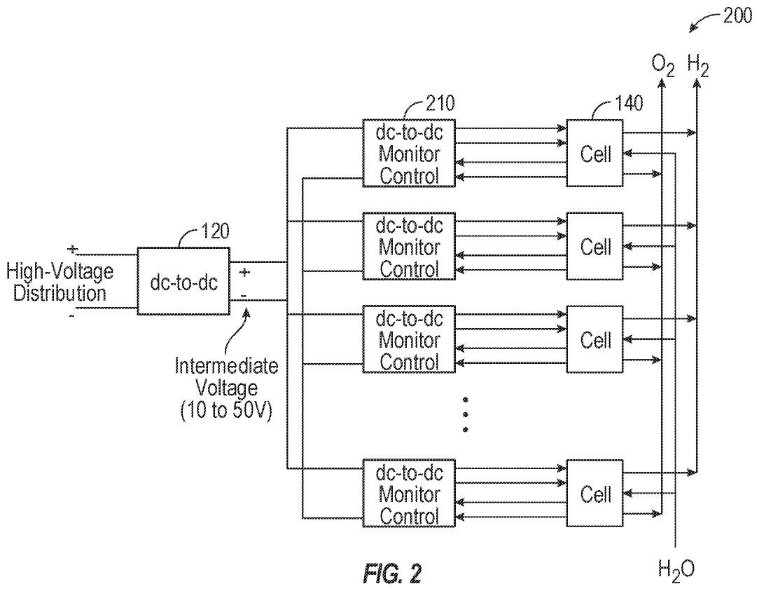

FIG. 2 is a block diagram of an example of an electrolyzer system 200, in accordance with various embodiments. The operation of electrolyzer system 200 is similar to that of electrolyzer system 100. Instead of delivering the same power and voltage to all of the electrolytic cells 140 in parallel, each electrolytic cell 140 includes an independent power supply and monitor control circuit 210. Specifically, the intermediate converter 120 provides a voltage between 10 and 50 volts to each of the independent power supply and monitor control circuits 210 in parallel. The independent power supply and monitor control circuit 210 then converts the voltage of 10 and 50 volts to an individual supply voltage between 1 and 2 volts for the given cell. In this way, one of the cells 140 can receive and operate at a first voltage (e.g., 1 volts) while a second of the cells 140 can receive and operate at a different second voltage (e.g., 2 volts).

According to this configuration, when the monitor control circuit 210 of a given cell 140 predicts based on measure parameters of the given cell 140 that the given cell 140 is being operated under conditions associated with an upcoming failure, the independent power supply and monitor control circuit 210 of the cell 140 can reduce the power and voltage being delivered to the corresponding cell 140 to increase the durability and lifetime of the cell or to temporarily disable operation of the cell 140. At the same time, when a given cell 140 is predicted by the associated monitor control circuit 210 to have parameters that indicate or are associated with a low performance, the independent power supply and monitor control circuit 210 of the cell 140 can increase the power and voltage being delivered to the corresponding cell 140 to increase the performance without reducing the durability and lifetime of the cell 140.

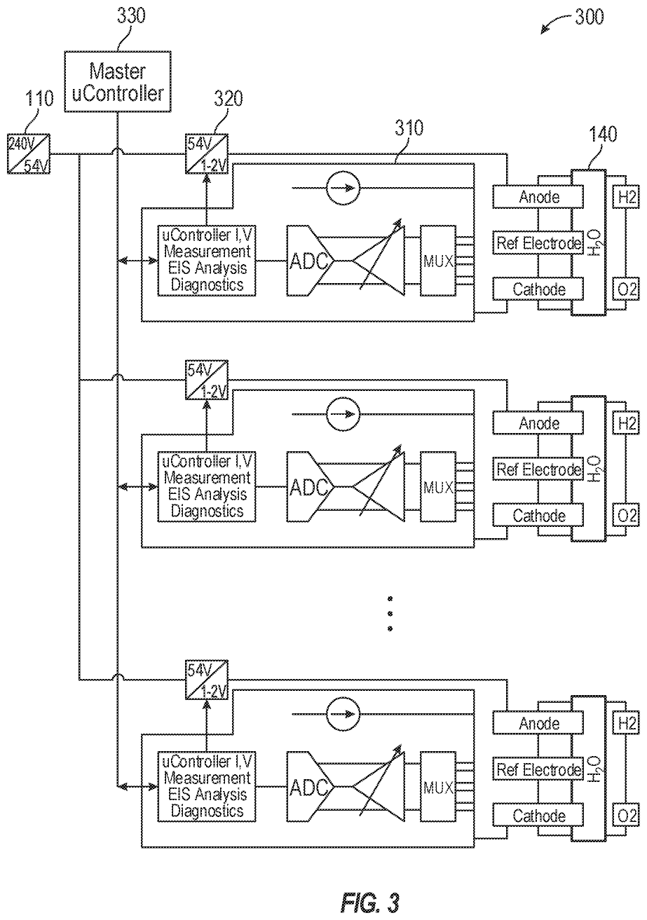

FIG. 3 is a block diagram of an example of an electrolyzer system 300, in accordance with various embodiments. Electrolyzer system 300 operates in a similar manner as electrolyzer system 200. As shown, each cell 140 is associated with a monitor circuit 310 and receives power from an individual power supply 320. Specifically, the individual power supplies 320 correspond to the individual power supplies of the monitor circuit 210 discussed in connection with FIG. 2. Namely, the individual power supplies 320 receive a voltage of between 10 and 50 volts that has been reduced from the 240 voltage generated by the high voltage distribution 110. The individual power supplies 320 convert the voltage of between 10 and 50 volts to an individual supply voltage between 1 and 2 volts for the given cell 140. This voltage is then applied to the anode of the cell 140.

The monitor circuit 310 associated with each respective cell 140 monitors parameters of the corresponding cell 140 and communicates such parameters to control circuitry 330, such as over the Internet. In one example, the monitor circuit 310 includes an ADC for generating the one or more parameters. The ADC can use a multiplexer to selectively measure voltages, currents, and temperature at various locations in the cell to generate the one or more parameters. In one example, the monitor circuit 310 can generate a local model for the associated cell based on the parameters of the cell it monitors. For example, the monitor circuit 310 can implement a machine learning model to analyze the one or more parameters to predict failure or performance of the cell and to thereby adjust the operating conditions of the cell 140 (e.g., increase the voltage generated by the individual power supply 320, decrease the voltage generated by the individual power supply 320, or temporarily disable the cell 140).

In some cases, the monitor circuit 310 provides the monitored and measured parameters to a remote control circuitry 330 (e.g., a central monitor circuit) that generates a model for the overall electrolyzer system 300. The model generated by the remote control circuitry 330 predicts or estimates performance, durability, and potential failure of the system 300 as a whole. The control circuitry 330 can control individual ones of the power supplies 320 to change the voltage and power being delivered to a given one of the cells 140 on an individual basis so that different voltage and power is delivered to the cells 140 in a way that maximizes durability and performance of the system 300.

The control circuitry 330 can use a communication protocol or interface to individually communicate with the monitor circuit 310 of each cell 140 on an individual basis (one at a time). The control circuitry 330 can also communicate an instruction to all of the monitor circuits 310 at the same time, such as to simultaneously increase power of all the cells 140 or decrease power of all the cells 140. This can be used to cause the cells 140 to generate oxygen and hydrogen faster or slower depending on the needs of the system 300.

In some embodiments, the control circuit 330 is trained to model performance and/or failure rate of cells 140 based on training data. For example, the control circuit 330 may implement a neural network. The neural network is trained to establish a relationship between a plurality of operating parameters (e.g., voltage across one or more of the plurality of electrolytic cells, EIS, current, temperature, and gas or fluid flow associated with the one or more of the plurality of electrolytic cells) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. The neural network can be trained to establish a set of parameters of the neural network based on such data to minimize a loss function. For example, the neural network can predict failure or performance metrics given a set of parameters in a set of the training data. The predicted failure or performance metrics can be compared with the actual ground truth failure or performance metrics of the set of training data. A loss can be computed based on a deviation between the predicted failure or performance metrics and the ground truth failure or performance metrics. Parameters of the neural network can then be updated based on the computed loss. Subsequent or additional training data sets can similarly be processed to update parameters of the neural network until a stopping criterion is satisfied or until all of the training data is processed.

This neural network with such updated parameters can then be stored or implemented by the control circuitry 330 and/or by the individual monitor circuits 310. In this way, when the neural network is presented with a new set of parameters of a given cell 140 or a collection of cells 140, the neural network can predict failure or performance metrics of the given cell 140 or the collection of cells 140. Based on the failure or performance metrics, voltage being delivered to the overall system and/or to individual cells 140 can be adjusted to optimize the failure or performance metrics.

Each individual cell can be locally controlled by the monitor circuit 310 that implements a local version of the neural network. Namely, when the monitor circuit 310 measures a set of parameters using an ADC for a first cell, the monitor circuit 310 applies the measured parameters to the local neural network. The local neural network can provide an individual assessment of the performance and failure of the associated first cell. Based on the individual assessment generated by the neural network, the monitor circuit 310 associated with the first cell can increase the voltage applied to the cell, decrease the voltage applied to the cell, turn OFF the cell for a period of time (which may be indicated or estimated by the neural network) or generate an alert to a system operator.

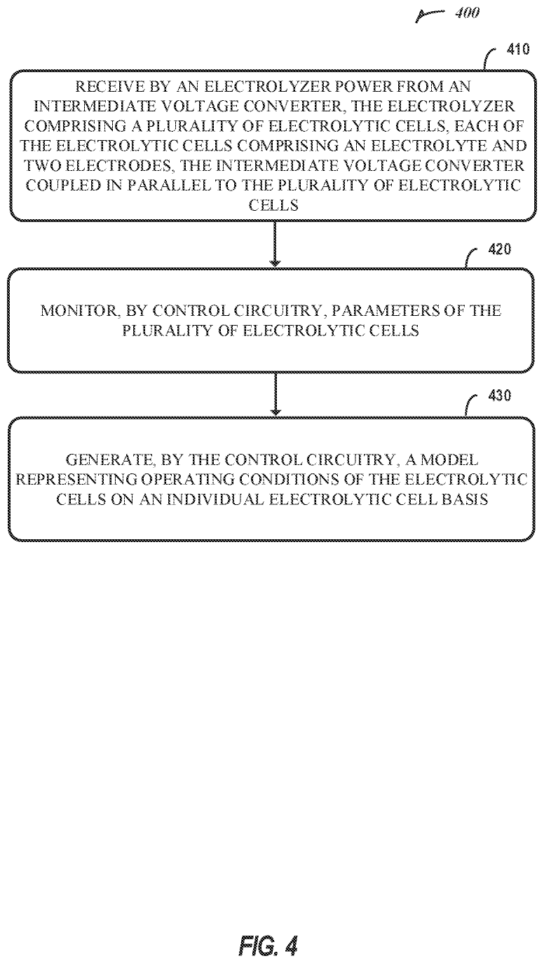

FIG. 4 is a flow diagram depicting example process 400 for operating or configuring an electrolyzer, in accordance with various embodiments. The operations of the process 400 may be performed in parallel or in a different sequence, or may be entirely omitted. In some embodiments, some or all of the operations of the process 400 may be embodied on a computer-readable medium and executed by one or more processors.

At operation 410, an electrolyzer receives power from an intermediate voltage converter. The electrolyzer includes a plurality of electrolytic cells, each of which includes an electrolyte and two electrodes. The intermediate voltage converter is coupled in parallel to the plurality of electrolytic cells.

At operation 420, control circuitry monitors one or more parameters of the plurality of electrolytic cells.

At operation 430, the control circuitry generates a model, based on the one or more parameters, representing operating conditions of the electrolytic cells on an individual electrolytic cell basis.

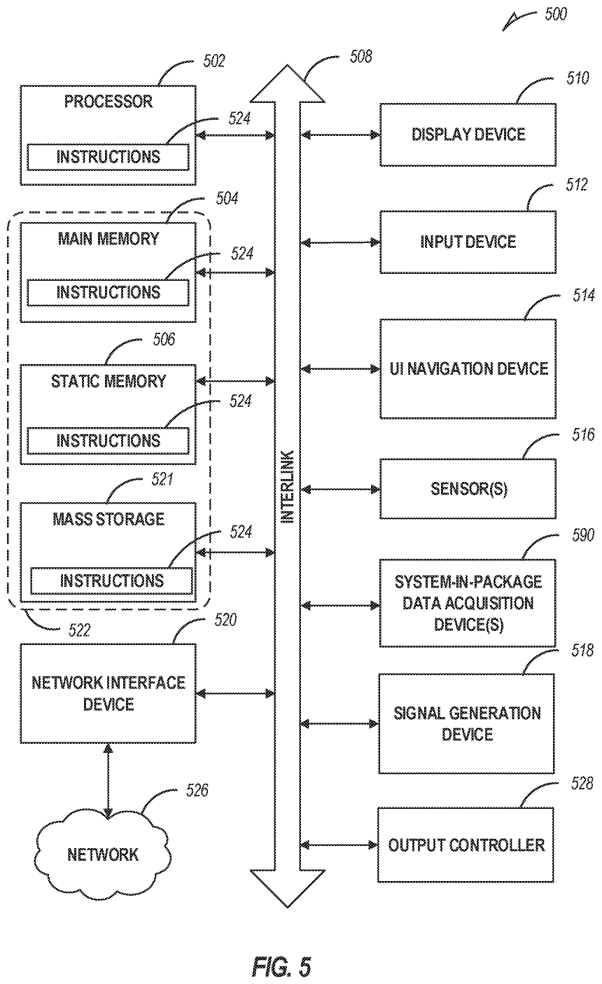

FIG. 5 is a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in a peer-to-peer (P2P) (or other distributed) network environment. The machine 500 may be a personal computer (PC), a tablet PC, a set-top box (STB), a personal digital assistant (PDA), a mobile telephone, a web appliance, an IoT device, an automotive system, an aerospace system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant-massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 500 may include a hardware processor 502 (e.g., a central processing unit (CPU), a graphics processing unit (GPU), a hardware processor core, or any combination thereof, such as a memory controller, etc.), a main memory 504, and a static memory 506, some or all of which may communicate with each other via an interlink (e.g., bus) 508. The machine 500 may further include a display device 510, an alphanumeric input device 512 (e.g., a keyboard), and a user interface (UI) navigation device 514 (e.g., a mouse). In an example, the display device 510, alphanumeric input device 512, and UI navigation device 514 may be a touchscreen display. The machine 500 may additionally include a storage device 522 (e.g., drive unit); a signal generation device 518 (e.g., a speaker); a network interface device 520; one or more sensors 516, such as a Global Positioning System (GPS) sensor, wing sensors, mechanical device sensors, temperature sensors, ICP sensors, bridge sensors, audio sensors, industrial sensors, a compass, an accelerometer, or other sensors; and one or more system-in-package data acquisition devices 590. The system-in-package data acquisition device(s) 590 may implement some or all of the functionality of the electrolyzer system 100. The machine 500 may include an output controller 528, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The storage device 522 may include a machine-readable medium on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 521 may constitute the machine-readable medium.

While the machine-readable medium is illustrated as a single medium, the term “machine-readable medium” may include a single medium or multiple media (e.g., a centralized or distributed database, or associated caches and servers) configured to store the one or more instructions 524.

The term “machine-readable medium” may include any transitory or non-transitory medium that is capable of storing, encoding, or carrying transitory or non-transitory instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 (e.g., software, programs, an operating system (OS), etc.) or other data that are stored on the storage device 521 can be accessed by the main memory 504 for use by the hardware processor 502. The main memory 504 (e.g., DRAM) is typically fast, but volatile, and thus a different type of storage from the storage device 521 (e.g., an SSD), which is suitable for long-term storage, including while in an “off” condition. The instructions 524 or data in use by a user or the machine 500 are typically loaded in the main memory 504 for use by the hardware processor 502. When the main memory 504 is full, virtual space from the storage device 521 can be allocated to supplement the main memory 504; however, because the storage device 521 is typically slower than the main memory 504, and write speeds are typically at least twice as slow as read speeds, use of virtual memory can greatly reduce user experience due to storage device latency (in contrast to the main memory 504, e.g., DRAM). Further, use of the storage device 521 for virtual memory can greatly reduce the usable lifespan of the storage device 521.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, P2P networks), among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible or intangible medium that is capable of storing, encoding, or carrying instructions for execution by the machine 500, and includes digital or analog communications signals or other tangible or intangible media to facilitate communication of such software.

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the inventive subject matter may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended; that is, a system, device, article, composition, formulation, or process that includes elements in addition to those listed after such a term in a claim are still deemed to fall within the scope of that claim. Moreover, in the following claims, the terms “first,” “second,” “third,” etc. are used merely as labels, and are not intended to impose numerical requirements on their objects.

Method examples described herein may be machine- or computer-implemented at least in part. Some examples may include a computer-readable medium or machine-readable medium encoded with transitory or non-transitory instructions operable to configure an electronic device to perform methods as described in the above examples. An implementation of such methods may include code, such as microcode, assembly-language code, a higher-level-language code, or the like. Such code may include transitory or non-transitory computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read-only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that an disclosed feature not listed in the list of claims is essential to any claim. Rather, inventive subject matter may lie in less than all features of a particular disclosed embodiment. Thus, the following claims are hereby incorporated into the detailed description as examples or embodiments, with each claim standing on its own as a separate embodiment, and it is contemplated that such embodiments may be combined with each other in various combinations or permutations. The scope of the inventive subject matter should be determined with reference to the appended claims, along with the full scope of equivalents to which such claims are entitled.

What is claimed is:

1. A system that includes an electrolyzer comprising a plurality of electrolytic cells, each of the electrolytic cells comprising an electrolyte and two electrodes, the system comprising:
a common voltage converter coupled in parallel to the plurality of electrolytic cells and configured to distribute power to the plurality of electrolytic cells; and
control circuitry coupled to the plurality of electrolytic cells, the control circuitry configured to:
monitor one or more parameters of the plurality of electrolytic cells; and
generate, based on the one or more parameters, a model representing operating conditions of the electrolytic cells on an individual electrolytic cell basis.

2. The system of claim 1, wherein the one or more parameters include at least one of voltage across one or more of the plurality of electrolytic cells, electro impedance spectroscopy (EIS), current, temperature, and gas or fluid flow associated with the one or more of the plurality of electrolytic cells.

3. The system of claim 1, further comprising an intermediate distribution device configured to provide an intermediate voltage to the common voltage converter.

4. The system of claim 3, wherein the intermediate distribution device steps down a first high voltage to a second lower voltage.

5. The system of claim 1, wherein the common voltage converter provides a first voltage level in parallel to the plurality of electrolytic cells, and wherein the electrolytic cells include individual power supplies that reduce the first voltage level of the power received from the voltage converter.

6. The system of claim 1, wherein the electrolyte comprises a water solution; and
wherein the electrolyzer is configured to output hydrogen and oxygen.

7. The system of claim 1, wherein a first of the electrolytic cells includes a first controller and a second of the electrolytic cells includes a second controller.

8. The system of claim 7, wherein the first controller generates a model representing an operating condition of the first electrolytic cell based on one or more parameters of the first electrolytic cell.

9. The system of claim 1, further comprising:
a communication interface coupled to the plurality of electrolytic cells, wherein the control circuitry communicates with a first of the plurality of electrolytic cells using the communication interface and obtains a parameter from the first of the plurality of electrolytic cells.

10. The system of claim 9, wherein the parameter comprises an impedance measurement of the first electrolytic cell.

11. The system of claim 1, wherein the control circuitry is configured to apply a current set of parameters of a given electrolytic cell of the plurality of electrolytic cells to the model, wherein the model is configured to estimate health or performance of the given electrolytic cell based on the current set of parameters.

12. The system of claim 1, wherein the model comprises a machine learning technique that is trained based on training data to predict health of an electrolytic cell, the training data comprising a plurality of training parameters and associated performance or failure information for the plurality of training parameters.

13. The system of claim 1, wherein the control circuitry comprises an analog to digital converter for measuring an analog value that represents the one or more parameters and for converting the analog value to a digital representation of the one or more parameters, wherein the control circuitry obtains the monitored one or more parameters over the Internet from the electrolyzer.

14. A method comprising:
providing, to an electrolyzer, power from a common voltage converter, the electrolyzer comprising a plurality of electrolytic cells, each of the electrolytic cells comprising an electrolyte and two electrodes, the common voltage converter coupled in parallel to the plurality of electrolytic cells;
monitoring, by control circuitry, one or more parameters of the plurality of electrolytic cells; and
generating, by the control circuitry, based on the one or more parameters, a model representing operating conditions of the electrolytic cells on an individual electrolytic cell basis.

15. The method of claim 14, wherein the one or more parameters include at least one of voltage across one or more of the plurality of electrolytic cells, current, electro impedance spectroscopy (EIS), temperature, and gas or fluid flow associated with the one or more of the plurality of electrolytic cells.

16. The method of claim 14, wherein the common voltage converter provides a first voltage level in parallel to the plurality of electrolytic cells, and wherein the electrolytic cells include individual power supplies that reduce the first voltage level of the power received from the common voltage converter.

17. The method of claim 14, further comprising:
selecting a first of the plurality of electrolytic cells using a communication interface; and
obtaining a parameter from the selected first of the plurality of electrolytic cells.

18. An apparatus comprising:
means for providing, to an electrolyzer, power from a common voltage converter, the electrolyzer comprising a plurality of electrolytic cells, each of the electrolytic cells comprising an electrolyte and two electrodes, the common voltage converter coupled in parallel to the plurality of electrolytic cells;
means for monitoring, by control circuitry, one or more parameters of the plurality of electrolytic cells; and
means for generating, by the control circuitry, based on the one or more parameters, a model representing operating conditions of the electrolytic cells on an individual electrolytic cell basis.

19. The apparatus of claim 18, wherein the one or more parameters include at least one of voltage across one or more of the plurality of electrolytic cells, current, electro impedance spectroscopy (EIS), temperature, and gas or fluid flow associated with the one or more of the plurality of electrolytic cells.

20. The apparatus of claim 18, wherein the common voltage converter provides a first voltage level in parallel to the plurality of electrolytic cells, and wherein the electrolytic cells include individual power supplies that reduce the first voltage level of the power received from the common voltage converter.
